(19) United States
(12) Patent Application Publication
(10) Pub. No.: US 2004/0068434 A1
(43) Pub. Date: Apr. 8, 2004

(54) System use support method, and server and program therefor

(75) Inventor: Tetsuya Kanekon, Kawasaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/662,324

(22) Filed: Sep. 16, 2003

(30) Foreign Application Priority Data
Sep. 20, 2002 (JP) 2002-275073

(51) Int. Cl. G06F 17/60

(52) U.S. Cl. 705/13; 705/1

(57) ABSTRACT

A center device includes an identification number management DB (database), a communications process unit, an information providing unit, and a parking charge payment process unit. The center device can be configured to provide a simple home page for mobile phones, and has a Web facility for user entry, data input, etc. for a payment. The center device can communicate with each parking meter by connection to a network. The center device obtains information about a parking charge, etc. from a corresponding parking meter at a request from a mobile phone of a user of a parking lot, and adjusts charge or provides information.

### BACKGROUND OF THE INVENTION

1. Field of the Invention

The present invention relates to the use of a system of billing users by a predetermined time, and more specifically to a method, a device, etc. capable of making a cashless payment using a user device and providing information in real time.

2. Description of the Related Art

There are short-time on-street parking zones and 24-hour parking lots without humans in attendance which are normally provided with parking meters. In these areas, users are to park their own vehicles in specified positions and make payments by a front-end payment, a back-end payment, or a combination of them (that is, a front-end payment and a back-end payment for supplementary charges). However, common parking meters are small and simple in configuration, and can accept small change only in most cases (100-yen coin only in many cases).

Therefore, the users have to prepare the small change, or exchange money if they have no small change, thereby being inconvenienced in making payments. Additionally, the users are anxious to know the current amounts billed for parking.

Furthermore, most on-street parking meters have upper time limits (normally 60 minutes or 40 minutes). If the upper limits are exceeded, the problem is more than supplementary charges, that is, an illegal on-street parking. In the worst case, the users are to pay a penalty. Therefore, they have to be always nervous about the time limit for parking, or accidentally exceeding the maximum time limit for parking.

In this connection, for example, the technology of transmitting a parking charge is computation result to a user device has been suggested (for example, Japanese Patent Laid-open No. 10-103976).

In addition to parking meters, any system (service) of billing users by a predetermined time can improve convenience for users if the system can provide information or make a payment in real time depending on the lapse of time.

### SUMMARY OF THE INVENTION

The present invention aims at providing a system, a method, etc. capable of making a cashless payment using a user device, and providing various information in real time.

First, a server according to the present invention is configured by including: a communications process unit for performing a communicating process through a network with a user device or a system of billing users by a predetermined time; and a payment process unit for obtaining information from the corresponding system at a payment request from the user device, obtaining charge information from the system through the network, and then making a payment.

Using the server with the above mentioned configuration, a cashless payment can be made using the user device when the system of billing users by a predetermined time is used, thereby providing convenience for uses.

Second, the server according to the present invention can be configured by including: a communications process unit for performing a communicating process through a network with a user device or a system of billing users by a predetermined time; and an information providing unit for obtaining the current use information from the corresponding system according to recorded information transmitted in advance from the user device, or at a request from the user device.

Using the server with the above mentioned configuration, the user can be informed of the current use during the use of the system of billing users by a predetermined time, and the user can make an appropriate determination on the further use of the system.

The above mentioned ‘system of billing users by a predetermined time’ can be, for example, a parking meter, etc., but is not limited to it. The above mentioned ‘user device’ can be, for example, a mobile phone, etc., but is not limited to it.

Third, the server according to the present invention can be configured by including: a communications process unit for performing a communicating process through a network with a user device; an information providing unit for obtaining the use information about the user using a system of billing users by a predetermined time, determining a transmission timing of a message according to the obtained use information, and transmitting the message with the transmission timing to the user device through the network; and a payment process unit for making a payment at a payment request from the user device.

For example, when the system of billing users by a predetermined time relates to various rental services, the server with the above mentioned configuration notifies the user device with a message each time a predetermined time has passed, and the server can make a payment on the user device which receives the message. For example, the user can be notified of, for example, an extension of a rental time, and can make a cashless payment.

The above mentioned problems can also be solved by allowing a computer to read a program stored in a computer-readable storage medium, and using it to direct the computer to perform the same function as that performed by each configuration according to the present invention.

### BRIEF DESCRIPTION OF THE DRAWINGS

FIG. 1 shows the configuration of the entire system of the parking use support system;

FIG. 2 shows an example of a data configuration of a identification number management DB (database);

FIG. 3 is a flowchart for explanation of the process performed when making a payment for parking charge;

FIG. 4 is a flowchart for explanation of the recording process when information is to be provided during the parking;

FIG. 5 is a flowchart for explanation of the information providing process during the parking;

FIGS. 6A through 6D show examples of data to be transmitted and received between the center device and a mobile phone;

FIG. 7 shows an example of the configuration of the hardware of the center device (computer); and

FIG. 8 shows examples of a storage medium storing a program used to direct a computer to perform the processes according to the present invention or downloading the program.

### DESCRIPTION OF THE PREFERRED EMBODIMENT

A plurality of embodiments are described below by referring to the attached drawings.

In the embodiments described below, using a parking meter (parking lot) is an example of a ‘system of billing users by a predetermined time’, and a mobile phone is an example of a ‘user device’ However, the embodiments are not limited to these applications, the detailed explanation of which is described below.

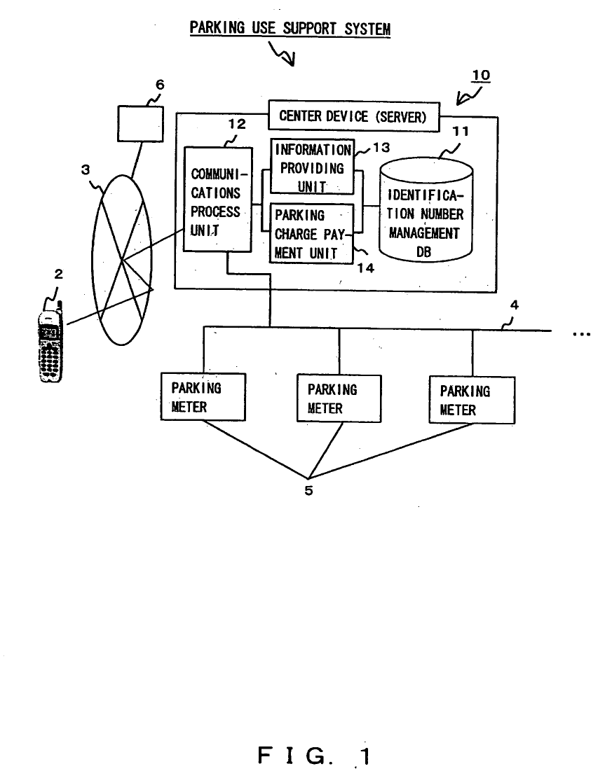

FIG. 1 shows the configuration of the entire system of the parking use support system according to an embodiment of the present invention.

The area designated as a short-time on-street parking area is not a parking lot strictly, but can be recognized as a type of parking lot in the following explanation.

In FIG. 1, a center device 10 and each parking meter 5 are connected to a network 4, and communicate with each other. The center device 10 can also communicate with a mobile phone 2 of each parking lot user through a network 3.

The network 3 can be, for example, a mobile phone network, Internet, etc. The network 4 can be a dedicated line (LAN, etc.), Internet, etc.

Each parking meter 5 is independently used for management of parking (a use state, a use starting time, an elapsed time, an arithmetic result such as a current parking charge, etc., temporary storage, a charge adjusting process, releasing a lock, etc.) and is similar to a conventional parking meter basically, but is different from the conventional parking meter in that the parking meter 5 can communicate with the center device (server) 10 through the network 4.

The center device (server) 10 comprises an identification number management (database) DB 11, a communications process unit 12, an information providing unit 13, and a parking charge payment unit 14. Although not shown in FIG. 1, the center device 10 can provide a simple home page as a Web facility for mobile phones to allow them to input data, etc. for record of a user and payment as described later. Otherwise, a Web server 6 provided with the Web facility can be separately included so that the Web server 6 can function as a window for access from the mobile phone 2 to the center device 10. In the following explanation, the center device 10 is provided with the Web facility.

With the above mentioned configuration, the identification number management DB 11 is a database storing for each parking meter 5, the identification number, and the IP address (and location data, etc.) as associated with each parking meter 5. An identification number is a unique number, etc. assigned in advance to each parking meter for unique identification. Additionally, the identification number is affixed to each parking meter 5 such that a user can visually recognize it.

As described in detail later, each parking user visually recognizes the identification number of the parking meter he or she uses, and inputs it on the mobile phone 2. The mobile phone 2 notifies the center device 10 of the identification number together with a parking charge payment request or a recording request described later.

The information providing unit 13 or the parking charge payment unit 14 of the center device (server) 10 refers to the identification number management DB 11, accesses the parking meter 5 at the address corresponding to the notified identification number, and obtains necessary information (parking charge, etc.), thereby performing an information providing process or a parking charge payment process as described later.

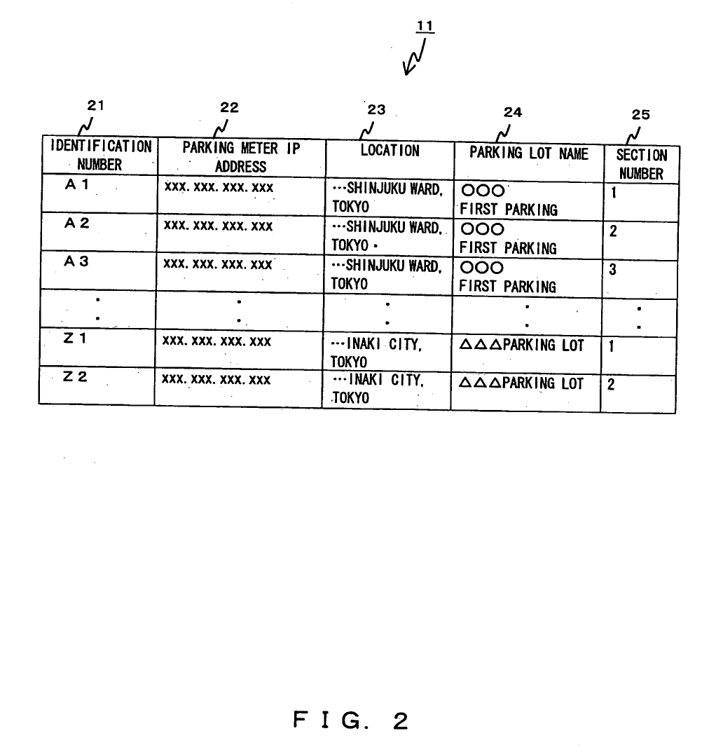

FIG. 2 shows an example of a data configuration of the identification number management DB 11.

The identification number management DB 11 shown in FIG. 2 comprises the fields of an identification number 21, a parking meter IP address 22, a location 23, a parking lot name 24, and a section number 25.

The identification number 21 has already been explained above. For example, by simply setting it as a combination of an alphabetical character +numeric character such as ‘A1’, ‘Z2’, etc. as shown in FIG. 2, a user can easily input it. The identification number 21 is not always required. For example, upon access from the mobile phone 2 of a user, a list of ‘the parking lot name 24+the section number 25’ is returned for display on the mobile phone 2 so that the user can select necessary data from the list. In this case, the identification number 21 is not required specifically. However, in the following explanation, an identification number is used in the configuration.

The parking meter IP address 22 is an IP address on the network 4 of each parking meter 5.

The location 23 indicates the address of the parking lot in which each parking meter 5 is mounted.

The parking lot name 24 indicates the name of a parking lot in which each parking meter 5 is mounted.

The section number 25 is the section number of the parking meter 5 in each parking lot.

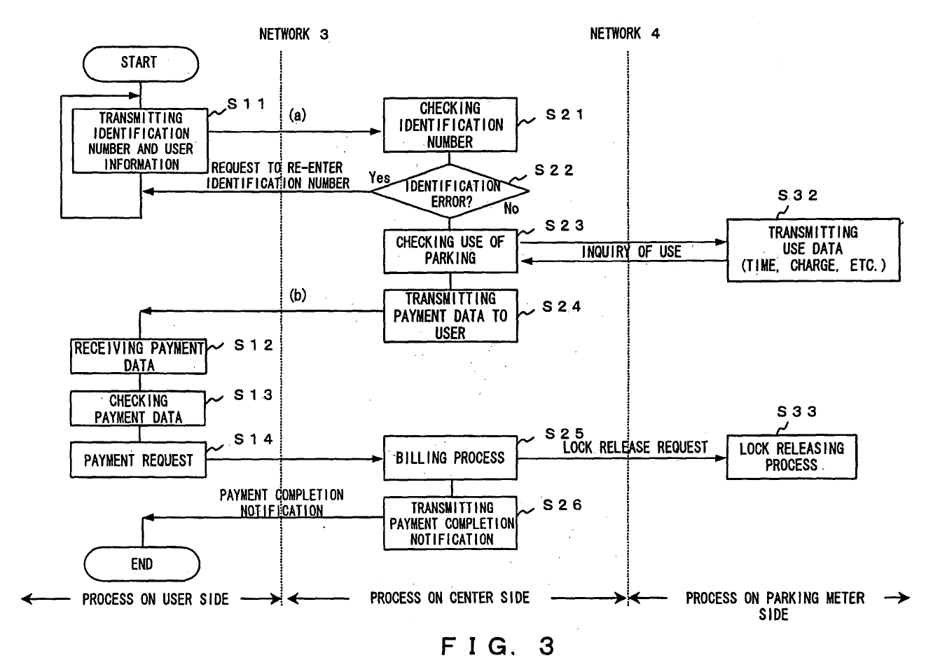

A parking charge payment process and a parking information providing process are described below by referring to FIGS. 3 through 6.

FIG. 3 is a flowchart for explanation of the process performed when making a payment for a parking charge.

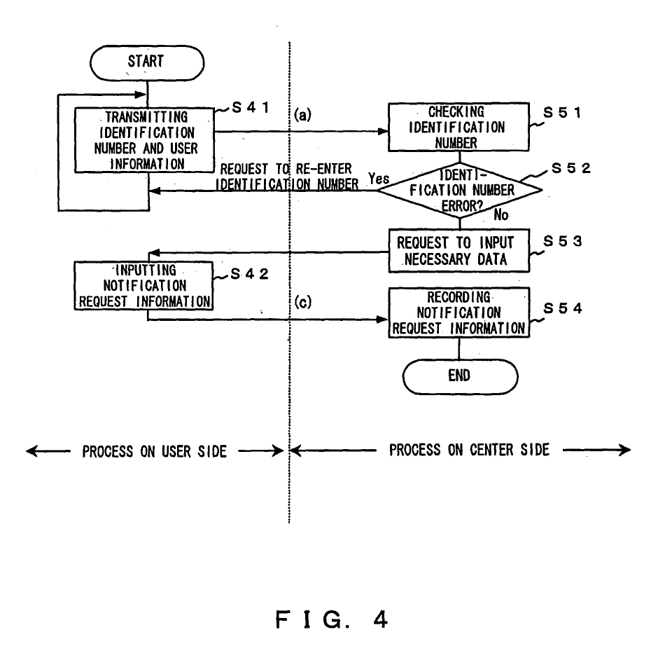

FIG. 4 is a flowchart for explanation of the recording process when information is to be provided during parking.

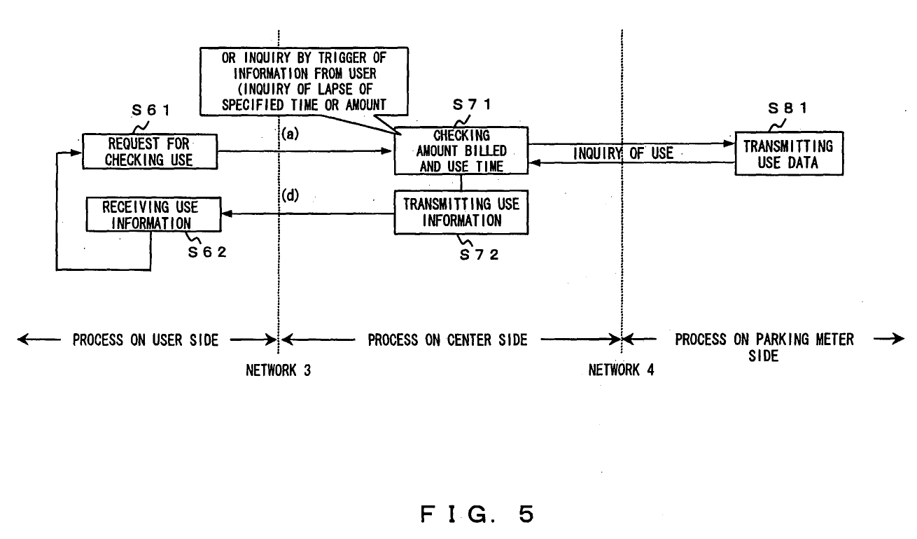

FIG. 5 is a flowchart for explanation of the information providing process during parking.

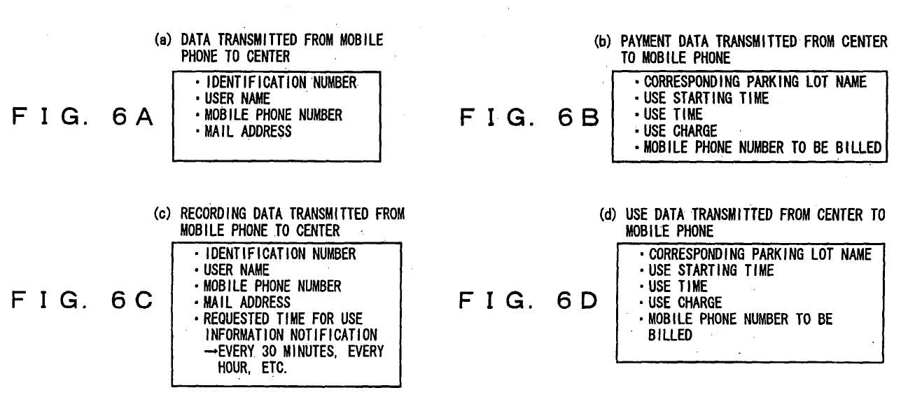

FIGS. 6A through 6D show examples of data transmitted and received in (a) through (d) shown in FIGS. 3 through 5.

First, the parking charge payment process is described below by referring to 7FIG. 3. This process is performed by the parking charge payment unit 14.

The timing of making a payment for parking charge depends on the charge payment system of each parking lot. That is, a payment is made depending on a front-end payment system, a back-end payment system, or a combination of a front-end payment and a supplementary charge payment.

First, as a premise, each parking meter 5 or in the vicinity of each parking meter 5, an identification number is indicated such that a user can visually recognize it together with the URL of the center device 10 (or the Web server 6).

After a user of a parking lot visually recognizes the identification number of the parking meter 5 he or she is going to use, and the URL, the user inputs the URL on his or her mobile phone 2, and accesses the center device 10. The center device 10 provides a simple home page for mobile phones as described above, and the simple home page is displayed by the display device of the mobile phone 2. Although not shown in the attached drawings, the contents of the menu of the simple home page including, for example, ‘parking charge adjusting’, ‘information providing and recording’, and ‘information request’ are displayed. In this example, the ‘parking charge adjusting’ is selected. Correspondingly, the parking charge adjustment screen appears such that the user can input an identification number and user information (user name, mobile phone number, mobile phone mail address, and other necessary information for payment using a common mobile phone). Thus, the mobile phone 2 transmits a parking charge adjust command including the input information (refer to (a) shown in FIG. 3, and also refer to FIG. 6A for an example) to the center device 10 (step S1).

Upon receipt of the parking charge adjust command, the center device 10 first determines whether or not the identification number has been recorded in the identification number management DB 11 (step S21). If an identification number not recorded in the identification number management DB 11 is transmitted due to an erroneous input by the user (YES in step S22), then a request to re-enter an identification number is transmitted to the mobile phone 2. Thus, the user performs again the process in step S11.

If the identification number has already been recorded in the identification number management DB 11 (NO in step S22), then the corresponding parking meter IP address 22 is obtained, the parking meter 5 of the IP address is requested to transmit use data, and the use data is obtained (step S23). (Upon receipt of the use data transmit request, the parking meter side simply performs the process of returning the use data managed and stored therein (step S31).

Based on the obtained use data, the center device 10 transmits payment data (refer to (b) shown in FIG. 3, and also refer to FIG. 6B for an example) to the mobile phone 2 of the user (step S24). The payment data (b) can be the use data (use starting time, use time, use charge, etc.) obtained in step S23 in the example shown in FIG. 6B, the corresponding parking lot name (the parking lot name 24 of the identification number management DB 11), the mobile phone number to be billed (the mobile phone number of (a)), etc., but the data is not limited to these examples.

The mobile phone 2 of the user receives the payment data (step S12), displays the data, and has the user check it (step S13). After checking the data, the user inputs the information about accepting paying the charge. Correspondingly, the mobile phone 2 transmits a payment request (step S14).

Upon receipt of the payment request, the center device 10 performs a billing process (step S25). The billing process can be performed in a common method which is not described here in detail. For example, a mobile phone company can be committed to collect the charge. When the billing process is completed, a lock release request is transmitted to the parking meter 5.

Upon receipt of the lock release request, the parking meter 5 releases the lock on the vehicle, and sets it free to be driven (step S32).

The center device 10 can further transmit a payment completion notification to the mobile phone 2 (step S26).

In the case of a parking meter provided for a short-time on-street parking zone, the process is almost the same as that shown in FIG. 3. There are only differences in the contents of use data and the processes in steps S25 and S32. That is, in this case, in the use data, the use time is the available time (normally 60 or 40 minutes as described above), and the use charge is a fixed amount depending on the available time. After the billing process in step S25, no lock release request is issued but, for example, a charge collection completion notification, is issued. Upon receipt of the notification, the process of ‘issuing a ticket’, ‘lighting a lamp’, etc. indicating the completion of the payment is performed.

The recording process performed when a user requests the presentation of information is described below by referring to FIG. 4. This process is performed by the information providing unit 13.

When a user requests the presentation of information, basically the recording process is performed when the use of a parking lot is started. Whether or not the recording process is to be performed is determined at the user's own discretion. Even without the recording process, the user can receive necessary information at any time as described later by referring to FIG. 5. However, higher convenience can be obtained after performing the recording process.

As shown in FIG. 4, after a user of a parking lot visually recognizes the identification number of the parking meter 5 to be used by the user and the URL when the use of the parking lot is started, the user operates the mobile phone 2, and inputs the URL, thereby accessing the center device 10. The center device 10 provides a simple home page presenting menus of ‘parking charge adjustment’, ‘entry for presentation of information’, ‘information request’, etc. for the user, and the user selects the ‘entry for presentation of information’. Thus, the information presentation entry screen appears, and prompts the user for an identification number and use information (user name, mobile phone number, mobile phone mail address, etc.). The mobile phone 2 transmits an information presentation entry command including the input information (refer to (a) shown in FIG. 4, and also refer to FIG. 6A for an example) to the center device 10 (step S41).

Upon receipt of the information presentation entry command, the center device 10 determines whether or not the identification number in the input information (a) has been recorded in the identification number management DB 11 (step S51). If it has not been recorded (YES in step S52), then the center device 10 transmits a request to reenter an identification number to the mobile phone 2.

When the recorded identification number has been checked (NO in step S52), then it further requests necessary data (notification request information) for recording (step S53). The mobile phone side prompts the user to input notification request information, and transmits the information (refer to (c) shown in FIG. 4, and also refer to FIG. 6C for an example) to the center device 10 (step S42). The center device side records the notification request information (step S54).

The notification request information can be, for example, a requested time for a use information notification, and indicates a request for a notification every 30 minutes, every hour, etc. as shown in FIG. 6C. This is only an example, and other requests can be issued. For example, a request for a notification to be received several minutes before a penalty, or a notification to be received immediately before the available time has passed (for example, five minutes before the available time) can be issued. However, in this case, it is necessary to access the corresponding parking meter 5 to obtain the information such as a use starting time, a billing method (various methods such as every 20 minutes, every 30 minutes, every hour, etc. can be used). Therefore, it is necessary to obtain information such as an available time, thereby recording the information together with the notification request information.

The process shown in FIG. 4 is an example, and the process is not limited to this application. For example, in the stage of the process in step S41, notification request information can be input (in this case, the processes in steps S53 and S42 are not required).

FIG. 5 is a flowchart of the process performed when information is provided.

The center device 10 automatically performs the processes in steps S71 and S72 shown in FIG. 5 according to the information recorded in step S54, but the processes are not limited to those, and the user can perform a predetermined operation on the user's mobile phone 2, issue a use check request (step S61), and perform a corresponding process.

In any case, the center device 10 accesses the corresponding parking meter 5 to provide information, and inquires about the current use (step S71). In response to this, the parking meter 5 returns the use data (the elapsed time, the use charge, etc.) stored and managed by the parking meter 5 to the center device 10 (step S81) . Upon receipt of the returned data, the center device 10 notifies the mobile phone 2 of the use (refer to (d) shown in FIG. 5, and also refer to FIG. 6D for an example) (step S72). The mobile phone 2 receives the use data, and displays it (step S62).

The process shown in FIG. 5 is only an example. For example, when a warning that an available time has almost passed is to be issued, it is not necessary to perform the process in step S71, and the process in step S72 is replaced with a warning message, etc. as a notification.

Anyway, the user can act without consideration of the time during the parking, thereby improving convenience for the user.

FIGS. 6A through 6D shows examples of the data transmitted and receives between the center device 10 and the mobile phone 2 as described above.

FIG. 6A shows an example of the data (refer to (a) shown in FIGS. 3, 4, and5) transmitted from the mobile phone 2 to the center device 10 when a parking charge is adjusted or recorded, or a use state is checked as shown in FIGS. 3, 4, and 5. The data can be the identification number of the parking meter used by the user, the user name, the mobile phone number of the mobile phone 2, the mail address, etc. as shown in FIG. 6A.

FIG. 6B shows an example the data (refer to (b) shown in FIG. 3) transmitted from the center device 10 to the mobile phone 2 when the parking charge is adjusted as shown in FIG. 3. The data can be the name (corresponding parking lot name) of the parking lot used by the user, the use starting time, the use time, the use charge, the phone number (mobile phone number to be billed) of the mobile phone 2 of the user, etc. as shown in FIG. 6B.

FIG. 6C shows an example of the data (refer to (c) shown in FIG. 4) transmitted from the mobile phone 2 to the center device 10 for the ‘recording process when a user requests the presentation of information’ as shown in FIG. 4. The data can be the identification number of the parking meter used by the user, the user name, the mobile phone number of the mobile phone 2, the mail address, the requested time for a use information notification etc. as shown in FIG. 6C. The requested time for a use information notification can be a requested time for a notification (for example, 2:30, etc.), a time interval (for example, every 30 minutes, every hour, etc.), and a moment immediately before an available time has passed (5 minutes before, etc.).

FIG. 6D shows an example of the data (refer to (d) shown in FIG. 5) transmitted from the center device 10 to the mobile phone 2 in the ‘information providing process’ shown in FIG. 5. The data can be the name (corresponding parking lot name) of the parking lot used by the user, the use starting time, the use time, the use charge, the phone number (mobile phone number to be billed) of the mobile phone 2 of the user, etc. as shown in FIG. 6D.

Thus, examples of the processes performed in the parking use support system according to the present embodiments are described above. However, the present invention is not limited to these embodiments. For example, in the examples above, the center device 10 inquires of each parking meter 5 about the use, but the center device 10 can manage the use of each parking meter. That is, the billing method for each parking lot (for example, a billing unit time (billing every 30 minutes, every hour, etc.), charge per billing unit time, etc.) can be first recorded in the center device 10 in advance. When each parking meter 5 detects the start of parking, it notifies the center device 10 of the start of parking. The center device 10 manages the use for each parking meter 5. Thus, the center device 10 can return the use data managed by itself to the mobile phone 2 without inquiring of each parking meter 5 about the data.

In the embodiments above, examples of parking meters (of a parking lot) are described. However, the present invention is not limited to the embodiments, but can be applied to all ‘systems (or services) for billing users by a predetermined time’. The ‘systems (or services) for billing users by a predetermined time’ can be, but not limited to, in addition to the above mentioned parking meter (of a parking lot), for example, various rental services of an audio CD, a video tape, a DVD, etc. for rent, a car for rent, etc.

Furthermore, relating to the various rental services, there can be a configuration of, for example, ‘notifying a user device of a message each time a predetermined time has passed, and making a payment on the user device which receives the message’. For example, the configuration can be set such that a message ‘Your rental video is overdue. The current overdue rate is 760 Japanese yen,’ etc. can be sent to remind the user of the return, and a cashless payment can be made for the overdue charge.

According to the above mentioned embodiments, an example of a device used by a user (to be referred to as a ‘user device’) is a mobile phone, but the present invention is not limited to mobile phones. For example, it can be a mobile phone itself, a personal computer connected to (or containing) a communications card type mobile phone or PHS (personal handy phone system), etc. In addition, for example, since there are services of accessing Internet (called a hot spot) by allowing general people to use a wireless LAN and use a personal computer, a PDA, etc., the above mentioned services can be applied to the personal computer, PDA, etc. Furthermore, the services can be applied not only to wireless communications but also to cable communications. As described above, the ‘user device’ is not limited to wireless/cable systems, but can be any data communications system. In the embodiments above, a mobile phone is used only as an example.

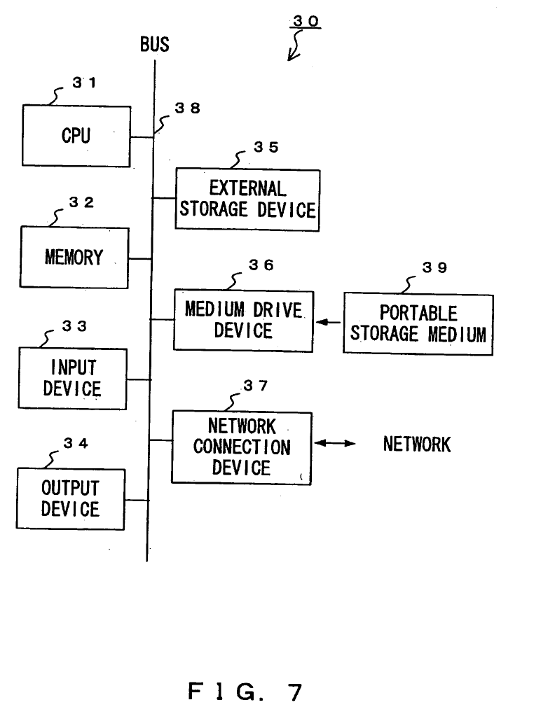

FIG. 7 shows an example of the hardware configuration of the above mentioned center device (computer).

Although the hardware configuration of a parking meter is not shown in the attached drawings, it is configured by adding a communications unit for communicating with the center device 10, by connection to the network 4 the hardware configuration of an existing parking meter (a processor, etc. for computing a parking charge, adjusting charge, lock/release control, etc., a display unit, etc.)

A computer 30 shown in FIG. 7 comprises a CPU 31, memory 32, an input device 33, an output device 34, an external storage device 35, a medium drive device 36, and a network connection device 37, all connected through a bus 38. The configuration shown in FIG. 7 is an example, and the present invention is not limited to the configuration.

The CPU 31 is a central processing device for controlling the entire computer 30.

The memory 32 can be RAM, etc. temporarily storing a program or data stored in the external storage device 35 (or a portable storage medium 39) when the program is executed, the data is updated, etc. The CPU 31 performs the above mentioned various processes using the program/data read to the memory 32.

The input device 33 can be, for example, a keyboard, a mouse, a touch panel, etc.

The output device 34 can be, for example, a display, a printer, etc.

The input device 33 and the output device 34 can be omitted.

The external storage device 35 can be, for example, a hard disk deice, etc., and stores a program/data, etc. (for example, a program/data, etc. used to direct a computer to perform each of the processes shown in FIGS. 3 though 5). Furthermore, the program/data, etc. is stored in the portable storage medium 39, the medium drive device 36 reads the program/data, etc. stored in the portable storage medium 39 to allow the computer 30 to perform the various processes shown in FIGS. 3 through 5. The portable storage medium 39 can be, for example, an FD (flexible disk), CDROM, a DVD, a magneto-optical disk, etc.

The network connection device 37 is connected to a network (Internet, etc.) for transmission and reception of a program/data to and from an external information processing device.

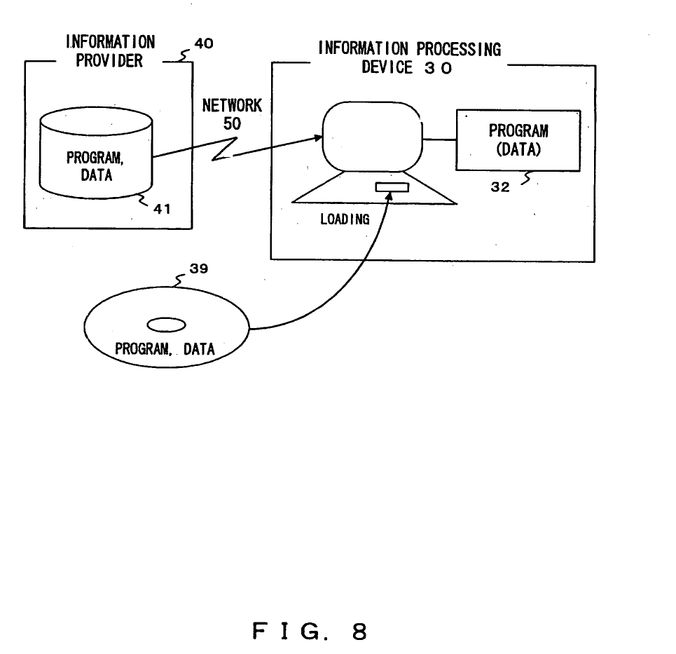

FIG. 8 shows an example of a storage medium storing the above mentioned program or downloading the program.

As shown in FIG. 8, the portable storage medium 39 storing a program/data for realizing the above mentioned functions of the present invention is inserted, etc. into the body of the computer 30 to read the program/data for storage in the memory 32 and then for extraction, or a program/data 41 stored in a server 40 on an external program/data provider side can be downloaded through a network 50 (Internet, etc.) connected through the network connection device 37.

Furthermore, the present invention can be configured as a storage medium (portable storage medium 39, etc.) itself storing the above mentioned program/data regardless of a device or a method, and also can be configured as a program itself.

As described above in detail, the system use support method, server, program, etc. according to the present invention, can easily make a payment relating to a ‘system of billing users by a predetermined time’ using a user device, and can provide various information (current use charge, etc.) useful to a user during the use of the system (service).

The above mentioned ‘system of billing users by a predetermined time’ can be, for example, a parking meter, etc., but the present invention is not limited to this application. The above mentioned ‘user device’ can be, for example, a mobile phone, etc., but the present invention is not limited to such device.

What is claimed is:

1. A server, comprising:
a communications process unit performing a communicating process with a user device and a system of billing a user by a predetermined time through a network; and
a payment process unit performing a payment by communicating with the system of billing a user by a predetermined time, and obtaining charge information from the system through the network.

2. A server, comprising:
a communications process unit performing a communicating process with a user device and a system of billing a user by a predetermined time through a network; and
an information providing unit obtaining current use information from the system of billing a user by a predetermined time according to recorded information transmitted in advance from the user device or at a request from the user device, and transmitting the obtained use information to the user device.

3. The server according to claim 2, wherein
when the payment is made in a front-end payment system for a predetermined time, a message is transmitted to the user device at any time before the predetermined time elapses.

4. The server according to claim 1, wherein
said system of billing a user by a predetermined time is a parking meter, and the charge is a parking charge for use of the parking meter.

5. The server according to claim 2, wherein
said system of billing a user by a predetermined time is a parking meter, and the charge is a parking charge for use of the parking meter.

6. A system use support method, comprising:
transmitting an identification number of a system of billing a user by a predetermined time and user information from a user device; and
obtaining an address of a system of billing a user by a predetermined time corresponding to the identification number, obtaining use information from the system at the address, and adjusting a charge or providing information.

7. The method according to claim 6, wherein
said system of billing a user by a predetermined time is a parking meter, and the charge is a parking charge for use of the parking meter.

8. A computer-readable storage medium storing a program used to direct a computer to perform the steps comprising:
performing a communicating process with a user device and a system of billing a user by a predetermined time through a network; and
performing a payment by communicating with the system of billing a user by a predetermined time, and obtaining charge information from the system through the network.

9. A computer-readable storage medium storing a program used to direct a computer to perform the steps comprising:
performing a communicating process with a user device and a system of billing a user by a predetermined time through a network; and
obtaining current use information from the system according to recorded information transmitted in advance from the user device or at a request from the user device, and transmitting the obtained use information to the user device.

10. The storage medium according to claim 8, wherein
said system of billing a user by a predetermined time is a parking meter, and the charge is a parking charge for use of the parking meter.

11. The storage medium according to claim 9, wherein
said system of billing a user by a predetermined time is a parking meter, and the charge is a parking charge for use of the parking meter.

12. A computer data signal embodied in a carrier wave storing a computer program used to direct a computer to perform the steps comprising:
performing a communicating process with a user device or a system of billing a user by a predetermined time through a network; and
performing a payment by communicating with the system of billing a user by a predetermined time, and obtaining charge information from the system through the network.

13. A computer data signal embodied in a carrier wave storing a computer program used to direct a computer to perform the steps comprising:
performing a communicating process with a user device and a system of billing a user by a predetermined time through a network; and
obtaining current use information from the system according to recorded information transmitted in advance from the user device or at a request from the user device, and transmitting the obtained use information to the user device.

14. A server, comprising:
a communications process unit performing a communicating process with a user device through a network;
an information providing unit obtaining use information about a user who uses a system of billing a user by a predetermined time, determining a transmission timing of a message according to the obtained use information, and transmitting the message to the user device through the network with the transmission timing; and
a payment unit for making a payment at a payment request from the user device.

15. A computer-readable storage medium storing a program used to direct a computer to perform the steps comprising:
performing a communicating process with a user device through a network;
obtaining use information about a user who uses a system of billing a user by a predetermined time, determining a transmission timing of a message according to the obtained use information, and transmitting the message to the user device through the network with the transmission timing; and
making a payment at a payment request from the user device.

16. A computer data signal embodied in a carrier wave storing a computer program used to direct a computer to perform the steps comprising:
performing a communicating process with a user device through a network;
obtaining use information about a user who uses a system of billing a user by a predetermined time, determining a transmission timing of a message according to the obtained use information, and transmitting the message to the user device through the network with the transmission timing; and
making a payment at a payment request from the user device.

17. A server, comprising:
communications process means for performing a communicating process with a user device and a system of billing a user by a predetermined time through a network; and
payment process means for performing a payment by communicating with the system of billing a user by a predetermined time, and obtaining charge information from the system through the network.
